(19) United States
(12) Patent Application Publication
(10) Pub. No.: US 2016/0299584 A1
(43) Pub. Date: Oct. 13, 2016

(54) STYLUS

(71) Applicant: ASUSTeK COMPUTER INC., Taipei City (TW)

(72) Inventor: Peter Timothy Clark, Taipei City (TW)

(21) Appl. No.: 15/080,611

(22) Filed: Mar. 25, 2016

Related U.S. Application Data
(60) Provisional application No. 62/144,948, filed on Apr. 9, 2015.

(51) Int. Cl. G06F 3/0354; G06F 3/01

(52) U.S. Cl. CPC G06F 3/03545; G06F 3/016

(57) ABSTRACT

A stylus includes a body portion, a flexible portion, and a tip. The flexible portion includes a proximal end connected to an end of the body portion, and a plurality of elastic parts radially connected from a distal end of the flexible portion. Each of the elastic parts is spaced apart. The tip is disposed on the distal end of the flexible portion.

### CROSS-REFERENCE TO RELATED APPLICATION

This application claims the priority benefit of U.S. provisional application Ser. No. 62/144,948, filed on Apr. 9, 2015. The entirety of the above-mentioned patent application is hereby incorporated by reference herein and made a part of this specification.

### BACKGROUND OF THE INVENTION

1. Field of the Invention

The invention is related to a stylus.

2. Description of Related Art

With advancement of electronic technologies, users mostly input data into electronic products through touch control display panels, and the touch control display panels allow the users to perform touch control not only through fingers but also through styluses. In addition, users desire styluses to simulate an actual feeling of writing utensils such as a brush or a pencil.

Conventional styluses are limited to a hard tip or a soft tip defined by the material of the tip of the stylus. A soft tip may replicate a finger of a user, but cannot replicate a brush or a marker. Therefore, conventional styluses cannot give physical feedback to the user so that the user has no actual feelings from the stylus that can replicate the physical feedback of writing utensils such as brushes or markers.

### SUMMARY OF THE INVENTION

The disclosure provides a stylus adapted to give feedback force in response to applied pressure from a user.

According to a first aspect of the present disclosure, a stylus comprises: a body portion; a flexible portion having a proximal end connected to an end of the body portion, the flexible portion comprising a plurality of elastic parts radially connected from a distal end of the flexible portion, wherein the plurality of the elastic parts are spaced apart from each other; and a tip, disposed on the distal end of the flexible portion.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a side view of a stylus according to an embodiment of the disclosure.

FIG. 2 is an exploded view of the stylus of FIG. 1.

FIGS. 3A to 3D are top views of different flexible portions interchangeable with the flexible portion of the stylus of FIG. 1.

FIGS. 4A to FIGS. 4D are schematic views of the flexible portions of FIGS. 3A to 3D.

FIG. 5 is a side view of a stylus according to another embodiment of the disclosure.

FIG. 6 is an exploded view of the stylus of FIG. 5.

### DESCRIPTION OF THE EMBODIMENTS

Reference will now be made in detail to the present preferred embodiments of the disclosure, examples of which are illustrated in the accompanying drawings. Wherever possible, the same reference numbers are used in the drawings and the description to refer to the same or like parts.

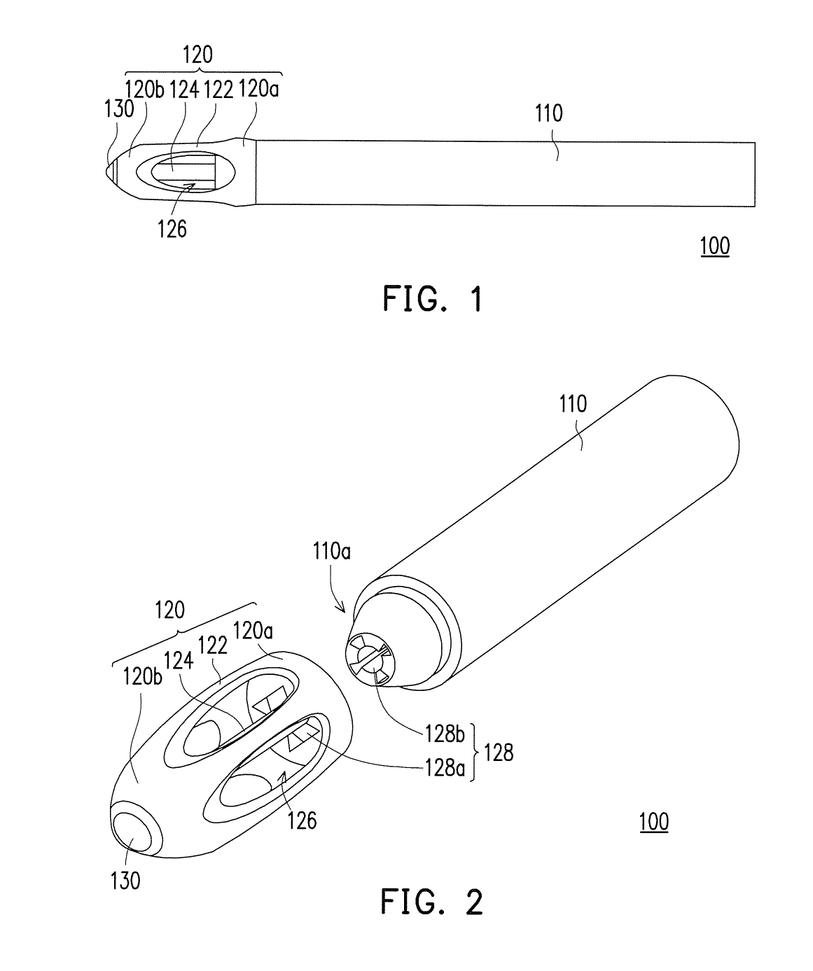

FIG. 1 is a side view of a stylus according to an embodiment of the disclosure. FIG. 2 is an exploded view of the stylus of FIG. 1. Referring to FIG. 1 and FIG. 2, the stylus 100 includes a body portion 110, a flexible portion 120, and a tip 130. The flexible portion 120 has a proximal end 120a and a distal end 120b. The proximal end 120a is connected to an end 110a of the body portion 110. The flexible portion 120 has a plurality of elastic parts 122 radially connected from the distal end 120b of the flexible portion 120. That is to say, each of the elastic parts 122 extends from the distal end 120b to the proximal end 120a. The plurality of elastic parts 122 are connected to each other at the proximal end 120a. More specifically, the proximal end 120a forms a closed loop that connects the plurality of elastic parts 122 for easily connected to the body portion 110. In the embodiment, the cross sections of the proximal end 120a and the body portion 110 are circles to match with each other. However, the disclosure is not limited thereto. The cross sections of the body portion 110 and the proximal end 120a of the flexible portion may be any shape desired by the user. For example, the cross sections may be squares, triangles, ovals, or other suitable shapes.

The at least plurality of elastic part 122 are spaced apart from each other. Particularly, in the embodiment, the plurality of elastic parts 122 are evenly spaced apart from each other. However, the disclosure is not limited thereto. The spacing between the elastic parts 122 may be adjusted according to the design and need of products.

In addition, as seen in FIG. 2, each of the elastic parts 122 is spaced apart to define a plurality of openings 126 and form a basket shape. In an embodiment, a number of the plurality of elastic part 122 is the same as a number of the plurality of openings 126. As seen in FIG. 1 and FIG. 2, the number of the elastic part 122 is four, and the number of openings 126 is four. The number of elastic part 122 may vary according to the design of the user. The stylus 100 requires the plurality of elastic part 122 with a radial arrangement in order to stabilize the tip 130 for the user to control movement better. Each of the openings 126 are the same size since that each of the elastic part 122 is evenly spaced apart. However, the disclosure is not limited thereto. The openings 126 may be of different sizes depending on how the elastic parts 122 are spaced apart from each other. Based on spacing of the elastic parts 122, the flexible portion 120 is hollow and empty.

In the embodiment, the flexible portion 120 is detachably connected to the end 110a of the body portion 110 through a locking mechanism 128. In particular, the flexible portion 120 further includes a spine 124 having a first end and a second end. The spine 124 acts as a support for the flexible portion 120, but is also flexible depending on the user. The first end of the spine 124 is connected to the distal end 120b of the flexible portion 120, and the second end of the spine 124 includes a locking head 128a. The end of the body portion 110 includes a locking hole 128b. The locking head 128a is adapted to be inserted and locked to the locking hole 128b so that the spine 124 is fixed to the end of the body portion 110. The locking head 128a and the locking hole 128b form the locking mechanism 128. Through the locking mechanism 128, the flexible portion 120 may be detachably connected to the body portion 110. As described in the embodiment and shown in FIG. 2, in an embodiment, the locking mechanism 128 is a bayonet mount, adapted to lock onto the end of the body portion 110.

The tip 130 is disposed on the distal end 120b of the flexible portion 120. The tip 130 may be any suitable type of stylus nib according to the user. The shape and material of the tip 130 may be various types know to one of ordinary skill in the art. The disclosure does not limit the type of tip 130 connected to the distal end 120b of the flexible portion 120.

In the embodiment, the stylus 100 generates a feedback force to the user according to the applied force of the user applying the stylus 100 onto a surface such as a touch screen. The feedback force from the stylus 100 is generated by the elastic parts 122. That is to say, as the user applies a downward force to the stylus 100 onto the surface, the elastic parts 122 enable a reaction force in the opposite direction. This reaction force in the opposite direction by the elastic parts 122 is based on Newton's Third Law of Motion (When one body exerts a force on a second body, the second body simultaneously exerts a force equal in magnitude and opposite in direction on the first body). Specifically, as the user presses the stylus 100 onto the surface, the elastic parts 122 deform and enable a reaction force in the opposite direction to provide a spring damping effect for the tip 130 of the stylus 100. This allows the user to get an actual physical feedback, such as a springy feeling, of the tip 130 of the stylus 100 as the user to using the stylus 100 on the touch screen. Furthermore, since the flexible portion 120 is a basket-like configuration, the elastic parts 122 are able to provide multi-directional response. That is to say, the elastic parts 122 are radially configured in the flexible portion 120, and the pressure feedback response towards the applied pressure of the user is radial. The elastic parts 122 may deform in any direction according to the force applied by the user. In combination with the spine 124, the flexible portion 120 is also able to provide an integrated linear response feedback. That is to say, the spine 124 of the flexible portion 120 is also capable of deforming in order to provide a feedback force corresponding to the applied force of the user.

The amount of deformation of the elastic parts 122 depend on the number of the elastic parts 122 and the thickness of the elastic parts 122. As the thickness of the elastic parts 122 increases, the stiffness also increases. In addition, more elastic parts 122 may result in a higher elastic constant, which will also increase the stiffness of the flexible portion 120. However, the number of elastic parts 122 by itself does not determine the stiffness of the flexible portion 120. A high number of elastic parts 122 with a small thickness may be less stiff than a flexible portion 120 with a low number of elastic parts 122 with a large thickness. The thickness and the number of the elastic parts 122 may be adjusted according to the desired stiffness of the flexible portion 120. Specifically, the stylus 100 may therefore allow users to experience different feedback forces according to the stiffness of the flexible portion. The stylus 100 may simulate the physical feeling of a writing utensil such as a brush, a marker, or a pencil. As different writing utensils have different stiffness and hardness values, the stiffness and hardness values of the flexible portion 120 of the stylus 100 may also be adjusted. This way, when the user is using the stylus 100, he or she may feel like an actual writing utensil is being used.

In the embodiment, the material of the flexible portion 120 and the elastic parts 122 may be plastic, rubber, or metal based. However, the disclosure is not limited thereto. Any type of suitable material for the flexible portion 120 and the elastic parts 122 may be selected to achieve the spring damping effect of the tip 130 when the stylus 100 is being used.

In the embodiment, the stylus 100 may be an active stylus. Therefore, the body portion 110 includes electrical components (not shown), and the spine 124 is electrically connected to the tip 130 and the electrical components of the body portion 110. The electrical components of the active stylus may include, for example, a power module, signal emitting module, an antenna or any other suitable components. Any suitable electrical components may be applied in the active stylus according to the functions desired by the active stylus. By having the spine 124 be electrically connected to the tip 130 and the electrical components of the body portion 110, a touch signal from the tip 130 may be transmitted to the electrical components of the body portion 110. However, the disclosure is not limited thereto. In other embodiments, the spine 124 is not electrically connected to the tip 130. In this case, the spine 124 acts as a support for the flexible portion 120, and not an electrical conductive element to transmit signals from the tip 130 to the body portion 110. The flexible portion 120 may be electrically conductive or include an additional conductive element on the interior side, such as a flexible printed circuit or any other suitable element. This way, the flexible portion 120 may be electrically connected to the tip 130 and the body portion 110. Thus, the touch signal from the tip 130 may be transmitted to the electrical components of the body portion 110 through the electrical elements of the flexible portion. However, the flexible portion 120 and the spine 124 may both be electrically connected to the tip 130 and the body portion 110 if desired by the user, the disclosure is not limited thereto.

In further embodiments, the stylus 100 may be a passive stylus. When the stylus 100 is a passive stylus, the spine 124 acts as a support for the flexible portion 120, and is not electrically connected to the tip 130 and the body portion. In addition, the flexible portion 120 is not electrically connected to the tip 130 and the body portion 110.

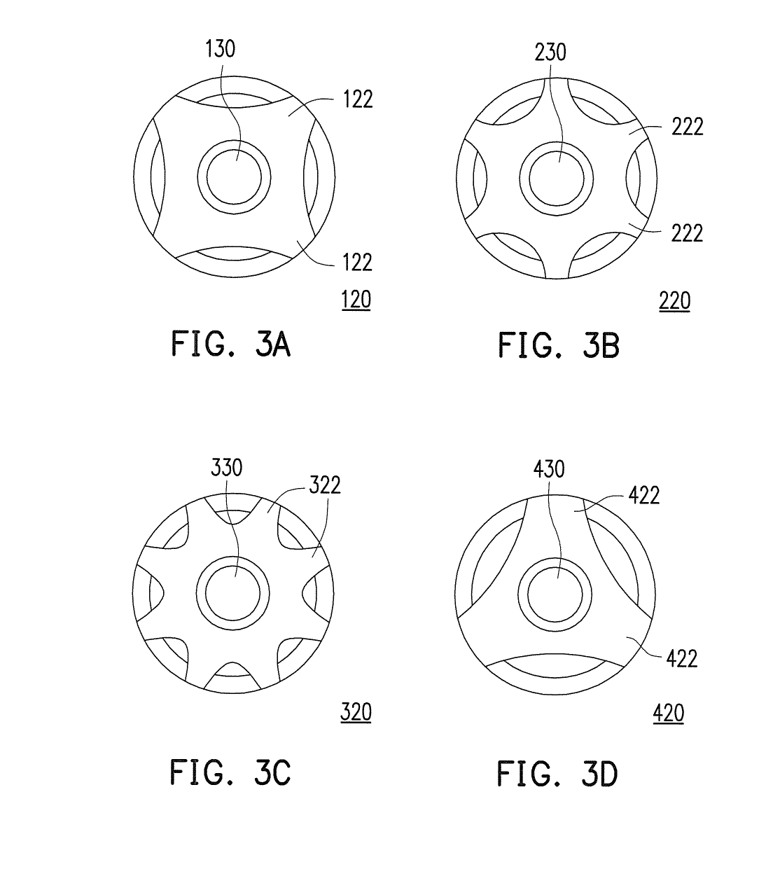

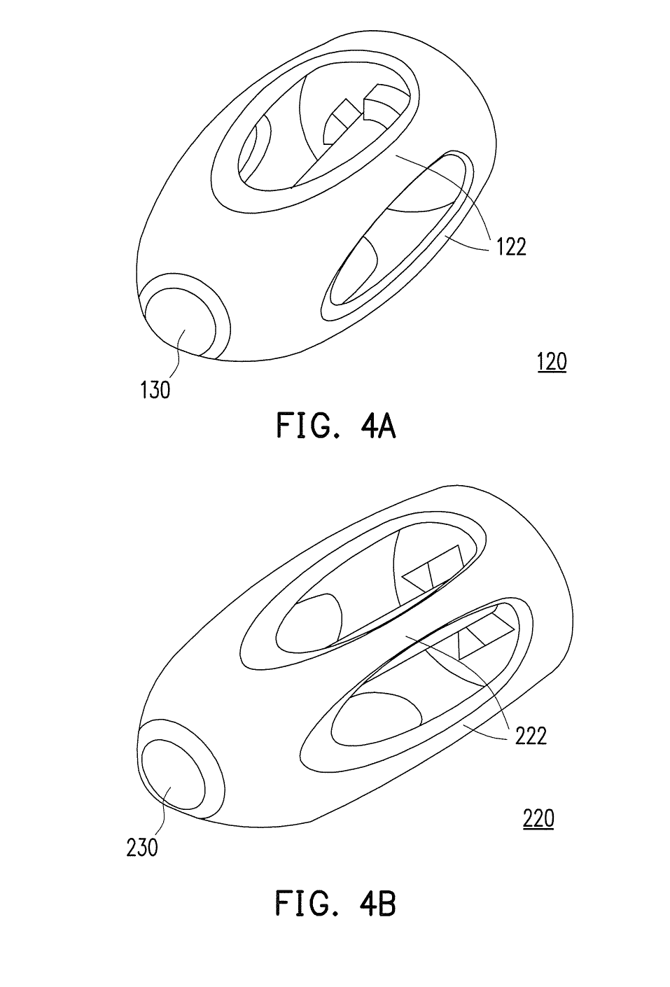

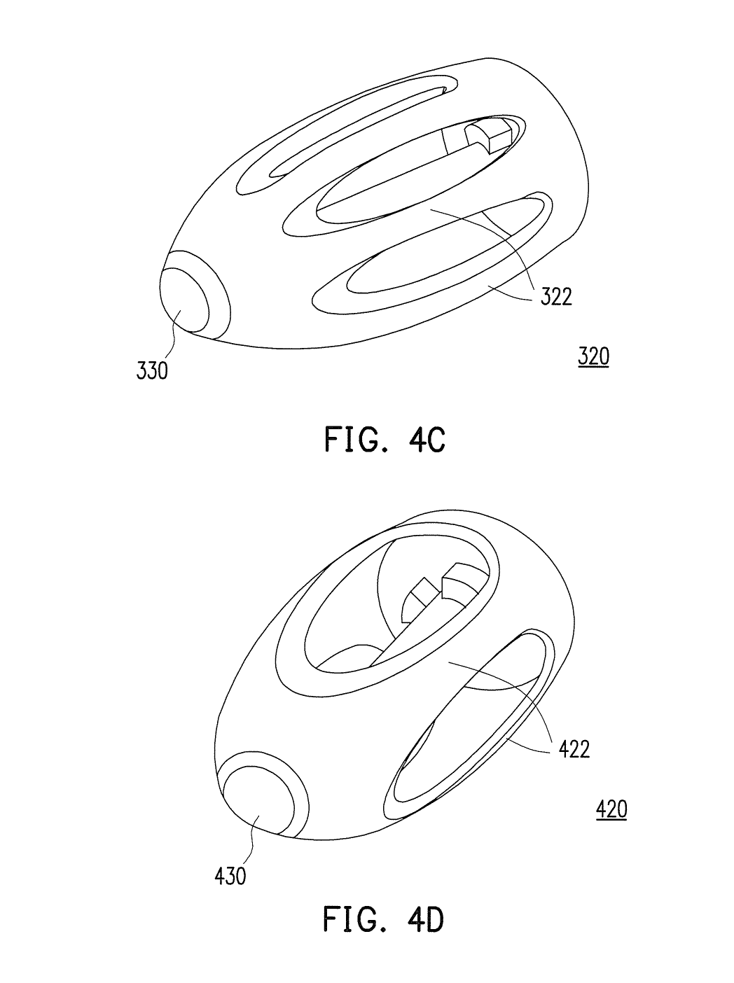

FIGS. 3A to 3D are top views of different flexible portions interchangeable with the flexible portion of the stylus of FIG. 1. FIGS. 4A to FIGS. 4D are schematic views of the flexible portions of FIGS. 4A to 4D. Referring to FIGS. 3A and 4A, FIGS. 3A and 4A show the flexible portion 120 and the tip 130 detached from the stylus 100. As described above, the flexible portion 120 includes four elastic parts 122.

Referring to FIGS. 3B and 4B, FIGS. 3B and 4B show a flexible portion 220 and a tip 230 disposed on the flexible portion 220. The flexible portion 220 may be attached to the stylus similar to the way the flexible portion 120 is attached to the stylus. It can be seen that the flexible portion 220 includes six elastic parts 222.

Referring to FIGS. 3C and 4C, FIGS. 3C and 4C show a flexible portion 320 and a tip 330 disposed on the flexible portion 320. The flexible portion 320 may be attached to the stylus similar to the way the flexible portion 120 is attached to the stylus. It can be seen that the flexible portion 320 includes eight elastic parts 322.

Referring to FIGS. 3D and 4D, FIGS. 3D and 4D show a flexible portion 420 and a tip 430 disposed on the flexible portion 420. The flexible portion 420 may be attached to the stylus similar to the way the flexible portion 120 is attached to the stylus. It can be seen that the flexible portion 420 includes plurality of elastic parts 422.

As described above, FIGS. 3A to 3D and the corresponding FIGS. 4A to 4D show a flexible portion with a different number of elastic parts. Each of the flexible portions 120, 220, 320, 420 is detachable and compatible to the stylus 100. The method of attachment is described above, and will not repeated herein. The different flexible portions 120, 220, 320, 420 depicted to show the basket shape that is formed from the elastic part being spaced apart. In addition, the different flexible portions 120, 220, 320, 420 shown are exemplary, and are shown to illustrate different amounts of elastic part that can be applied in the flexible portions to simulate different writing utensils. For example, FIG. 3A shows the flexible portion 120 with four elastic parts 122, which may simulate a crayon. FIG. 3B shows the flexible portion 220 with six elastic parts 222 that are thinner than four elastic parts 122 are applied, and may simulate a marker that is softer than a crayon. FIG. 3C shows the flexible portion 320 with eight elastic parts 322 that are thinner than the elastic parts 122 and the elastic part 222. The stylus 100 with the flexible portion 320 may simulate a brush that is softer than a crayon and a marker. The elastic part 322 may simulate the hairs of the brush. FIG. 3D shows the flexible portion 420 with plurality of elastic part 422 thicker than the elastic part 122. The stylus 100 with the flexible portion 420 may simulate, for example, a pencil that is harder than a crayon and a marker.

The different writing utensils that FIGS. 3A to 3D may simulate are merely exemplary and used to better describe the embodiment. FIGS. 3A to 3D may simulate other writing utensils based on the number and thickness of the elastic part, and the overall design of the flexible portion. In addition, the material of the flexible portion may also affect the stiffness and hardness of the stylus, and may be a factor in the type of writing utensil that is simulated.

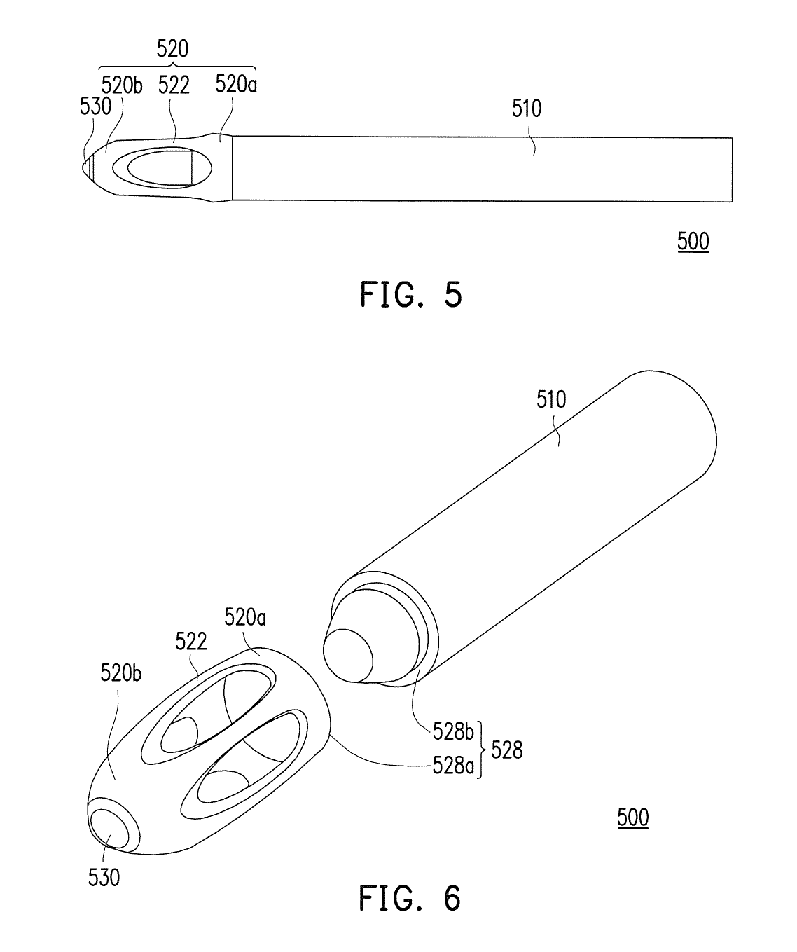

FIG. 5 is a side view of a stylus according to another embodiment of the disclosure. FIG. 6 is an exploded view of the stylus of FIG. 5. Referring to FIG. 5 and FIG. 6, the stylus 500 of FIG. 5 and FIG. 6 is similar to the stylus 100 of FIG. 1 and FIG. 2. The difference is the stylus 500 does not include the spine 124 and the locking mechanism 128. That is to say, the stylus 500 does not attach the body portion 510 to the flexible portion 520 through the locking mechanism. The stylus 500 includes a tip 530, and the flexible portion 520 includes the elastic parts 522. The flexible portion 520 has a proximal end 520a and a distal end 520b.

In the embodiment, the stylus 500 does not include the locking mechanism 128, but includes a locking mechanism 528 to detachably connect the body portion 510 to the flexible portion 520. The locking mechanism 528 includes a first locking portion 528a located at an end of the body portion 510. The locking mechanism 528 further includes a second locking portion 528b located at the proximal end 520a of the flexible portion 520. When connected the body portion 510 and the flexible portion 520, the first locking portion 528a is locked with the second locking portion 528b. The locking mechanism 528 may be a bayonet mount type locking mechanism. However, the disclosure is not limited thereto. The locking mechanism 528 may be any suitable type of locking mechanism. In addition, the locking mechanism 528 may also be included in the stylus 100 of FIG. 1 and FIG. 2. That is to say, the flexible portions in FIG. 3A to FIG. 3D along with the stylus 100 may include the locking mechanism 528 to further attach the flexible portion to the stylus 100. However, the disclosure is not limited thereto. The locking mechanism 528 does not have to be included in the stylus 100.

In the embodiment, the flexible portion 520 is similar to the flexible portion 120 of FIG. 3A, except that the flexible portion 520 does not include the spine 124. The flexible portion 520 may also have different variations in the elastic part 522 similar to the different flexible portions depicted in FIG. 3B to FIG. 3D. That is to say, the stylus 500 may switch between different flexible portions with different number of elastic part to simulate various writing utensils. The exemplary types of writing utensils that may be simulated are described above, and will not be repeated herein.

In the embodiment, the stylus 500 may be an active stylus. That is to say, the flexible portion 520 may be electrically conductive or include an additional conductive element on the interior side, such as a flexible printed circuit or any other suitable element. How the stylus 500 may be an active stylus can be referred to in the description of the stylus 100, and further description will not be repeated herein.

Based on the above, the stylus includes a flexible portion that has a plurality of elastic part. This way, the user is able to control the movement of the tip of the stylus through a spring mechanism in a precise way. By having the elastic part, the user can experience a more linear response, and the elastic part can deform in an amount according to the pressure of the user. Therefore, the user can feel the pressure applied and see the result of the pressure applied towards the flexible portion. The stylus may switch between different flexible portions that have different elastic part. The different number of elastic part can simulate different springy feelings. Since the flexible portions are interchangeable, the user may choose the flexible portion to attach to the stylus according to the writing utensil desired to be simulated.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A stylus comprising:
a body portion;
a flexible portion having a proximal end connected to an end of the body portion, the flexible portion comprising a plurality of elastic parts radially connected from a distal end of the flexible portion, wherein the plurality of elastic parts are spaced apart from each other; and
a tip, disposed on the distal end of the flexible portion.

2. The stylus as claimed in claim 1, wherein each of the elastic parts is evenly spaced apart from each other.

3. The stylus as claimed in claim 1, wherein each of the elastic parts extends from the distal end to the proximal end, and are connected to each other at the proximal end.

4. The stylus as claimed in claim 1, wherein the plurality of the elastic parts define a plurality of openings, wherein a number of the elastic parts is the same that of the openings.

5. The stylus as claimed in claim 1, wherein the flexible portion is detachably connected to the end of the body through a locking mechanism.

6. The stylus as claimed in claim 5, wherein the flexible portion further comprises a spine having a first end and a second end, the first end is connected to the distal end of the flexible portion, and the second end includes a locking head of the locking mechanism so as to be attached to the end of the body portion.

7. The stylus as claimed in claim 6, wherein the spine is electrically connected to the tip and the body portion.

8. The stylus as claimed in claim 1, wherein the flexible portion is electrically connected to the tip and the body portion.

9. The stylus as claimed in claim 5, wherein the locking mechanism of the flexible portion is a bayonet mount, adapted to lock the end of the body portion.

10. The stylus as claimed in claim 6, wherein the locking head of the locking mechanism is a bayonet mount, adapted to lock a locking hole at the end of the body portion.
